(19) United States
(12) Patent Application Publication
(10) Pub. No.: US 2025/0323723 A1
(43) Pub. Date: Oct. 16, 2025

(54) CHARACTERIZING OPTICAL TRANSMITTER QUALITY WITH FEC ENCODED DATA

(71) Applicant: Cisco Technology, Inc., San Jose, CA (US)

(72) Inventors: Adee O. RAN, Maayan Baruch (IL); Mark C. NOWELL, Ottawa (CA); Thomas H. TOIFL, Thalwil (CH); Upendranadh R. KARETI, Union City, CA (US); Brian P. WELCH, San Diego, CA (US)

(21) Appl. No.: 19/065,979

(22) Filed: Feb. 27, 2025

Related U.S. Application Data
(60) Provisional application No. 63/633,497, filed on Apr. 12, 2024.

(51) Int. Cl. H04B 10/077; H04B 10/073; H04B 10/524

(52) U.S. Cl. CPC H04B 10/0775; H04B 10/0731; H04B 10/524

(57) ABSTRACT

The embodiments herein describe a modified TDECQ that can measure correlated noise (i.e., non-random noise). Instead of generating a single histogram for a TDECQ test pattern (e.g., which can include thousands of symbols), the embodiments herein generate a respective histogram for each of the symbols of the test pattern (e.g., thousands of histograms). These individual histograms can be processed to determine an error probability for each symbol, which can provide valuable insight into correlated errors.

### CROSS-REFERENCE TO RELATED APPLICATIONS

This application claims benefit of co-pending U.S. provisional patent application Ser. No. 63/633,497 filed Apr. 12, 2024. The aforementioned related patent application is herein incorporated by reference in its entirety.

### TECHNICAL FIELD

Embodiments presented in this disclosure generally relate to a modified Transmitter and Dispersion Eye Closure Quaternary (TDECQ).

### BACKGROUND

TDECQ is a metric used to measure the performance of an optical transmitter. TDECQ is used to calculate the amount of extra power needed to compensate for a transmitter's imperfections. That is, TDECQ is defined based on the histogram of transmitter samples collected from a test signal. TDECQ corresponds to the level of noise that can be added to the transmitted signal while still meeting a target for, e.g., pulse amplitude modulation (PAM) such as PAM4 symbol error ratio (PAM4 SER).

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates a testing system for an optical transmitter, according to one embodiment.

FIG. 2 is a flowchart for generating a TDECQ measurement that accounts for deterministic (nonrandom) errors, according to one embodiment.

FIG. 3 illustrates histograms for a series of symbols in a testing pattern used to calculate TDECQ, according to one embodiment.

FIG. 4 is a flowchart for generating a TDECQ measurement for an inner forward error correction (FEC), according to one embodiment.

FIG. 5 is a flowchart for generating a TDECQ measurement for an outer FEC, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is a method that includes generating a respective histogram for each of a plurality of symbols of a test pattern by receiving the test pattern repeatedly from an optical transmitter, identifying a value of an additive noise parameter that satisfies a failure probability threshold by determining a probability of errors for each of the plurality of symbols using different values of the additive noise parameter, and determining Transmitter and Dispersion Eye Closure Quaternary (TDECQ) using the value of the additive noise parameter.

One embodiment presented in this disclosure is a measurement system that includes one or more memories and one or more processors communicatively coupled to the one or more memories, the one or more processors configured to, individually or collectively, perform operations. The operations include generating a respective histogram for each of a plurality of symbols of a test pattern by receiving the test pattern repeatedly from an optical transmitter, identifying a value of an additive noise parameter that satisfies a failure probability threshold by determining a probability of errors for each of the plurality of symbols using different values of the additive noise parameter, and determining TDECQ using the value of the additive noise parameter.

One embodiment presented in this disclosure is a computer readable medium comprising, in any combination, computer program code, which, when executed by one or more processors, performs operations. The operations generating a respective histogram for each of a plurality of symbols of a test pattern by receiving the test pattern repeatedly from an optical transmitter, identifying a value of an additive noise parameter that satisfies a failure probability threshold by determining a probability of errors for each of the plurality of symbols using different values of the additive noise parameter, and determining TDECQ using the value of the additive noise parameter.

### EXAMPLE EMBODIMENTS

The embodiments herein describe a modified TDECQ that can measure correlated noise (i.e., non-random noise). Put differently, previous TDECQ measurements assumed errors and noise are random. However, an optical transmitter (TX) that has a constant level of noise over a time period may have the same TDECQ as another TX that experiences bursts of random noise but the rest of the time is high quality. The fact that the noise can be correlated noise can be detected using the modified TDECQ measurement techniques described herein, thereby providing a more accurate and useful TDECQ measurement.

Instead of generating a single histogram for a TDECQ test pattern (e.g., which can include thousands of symbols), the embodiments herein generate a respective histogram for each of the symbols of the test pattern (e.g., thousands of histograms). These individual histograms can be processed to determine an error probability for each symbol, which can provide valuable insight into correlated errors. This means the resulting TDECQ measurement enables performance estimation of forward error correction (FEC) codes algorithms, such as inner and outer FEC codes, which are very susceptible to correlated errors. For example, a Hamming decoder (which is one example of an inner FEC code) may be able to correct as most three errors in a codeword (e.g., 128 symbols or unit interval (UI)). The modified TDECQ measurement can indicate the probability of an optical TX generating more than three errors in a codeword.

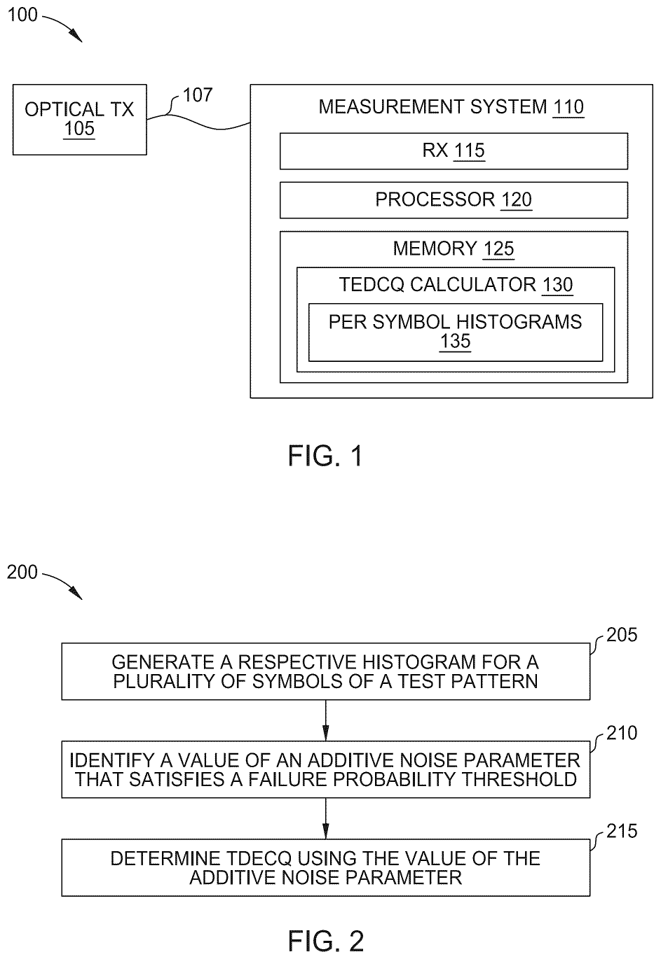

FIG. 1 illustrates a testing system 100 for an optical TX 105, according to one embodiment. The optical TX 105 can include a laser that uses a modulation scheme (e.g., PAM4, PAM8, etc.) to transmit an optical signal to a measurement system 110 using an optical fiber 107. While the embodiments herein primarily discuss PAM4, the techniques can be applied to any amplitude modulation scheme.

The measurement system 110 includes a receiver (RX) 115 that receives and decodes the optical signal transmitted by the TX 105, a processor 120, and memory 125. The processor 120 and memory 125 can be part of a computing system that is used to generate a TDECQ measurement using the information provided by the RX 115. The processor 120 can represent any number of processing elements that can include any number of processing cores. The memory 125 can include one or more memories that can be volatile memory elements, non-volatile memory elements, and combinations thereof.

The memory 125 stores a TDECQ calculator 130 (e.g., a software application or software module) that calculates the TDECQ for the optical TX 105 as described below. To do so, the TDECQ calculator 130 calculates histograms 135 for each symbol used in a test pattern transmitted by the optical TX 105, unlike the previous TDECQ technique of calculating a histogram for the entire test pattern. For example, if the test pattern includes 64 k symbols, then the TDECQ calculator 130 may generate 64 k histograms. To do so, the testing system 100 may instruct the optical TX 105 to transmit the test pattern repeatedly to generate different samples for each symbol to generate the per symbol histograms 135. For example, the testing system 100 may use a 1000 samples per symbol in the test pattern to generate the histograms 135.

As discussed in more detail below, the per symbol histograms 135 can be used to determine a probability of error (and failure) on a per symbol basis, rather than an average probability of error for the entire test pattern as done previously. As discussed in more detail below, noise can be (mathematically) added to the histograms until reaching a symbol error ratio. The system can identify the maximum value of noise that can be added to the histograms that still satisfies a failure probability threshold (e.g., the maximum probability of failure, which can be a parameter set by a user). The TDECQ can then be calculated using this noise value.

FIG. 2 is a flowchart of a method 200 for generating a TDECQ measurement that accounts for deterministic (nonrandom) errors, according to one embodiment. At block 205, the TDECQ calculator generates a respective histogram for each of a plurality of symbols of a test pattern. One example test pattern that can be used to measure TDECQ is the short stress pattern random quaternary (SSPRQ) test pattern which is 2\hat{ }16−1=65535 symbols (or UI) in length. The discussion below will assume the SSPRQ test pattern is used, but the techniques herein can apply to any suitable test pattern.

The measurement system can capture a signal where the test pattern is repeated to provide sufficient samples to create a histogram for each symbol (or UI) in the test pattern. For example, the test pattern can be repeated to provide 1000 samples for each symbol in the test pattern. These 1000 samples can then be used to generate a histogram for each symbol.

Moreover, in other embodiments, the measurement system may not create a histogram for every symbol in the test pattern. For example, the measurement system may generate a histogram for every other symbol in the test pattern, or for a specified threshold of the symbols in the test pattern (e.g., at least 90%).

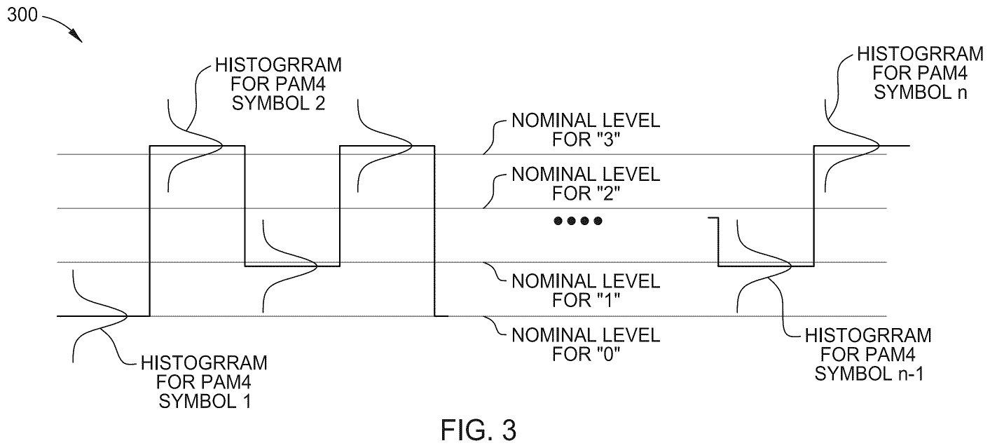

FIG. 3 illustrates histograms for a series of symbols in a test pattern 300 used to calculate TDECQ, according to one embodiment. The test pattern 300 includes symbols (i.e., symbols 1-n). In addition, FIG. 3 illustrates that the test pattern has been repeated so the measurement system can collect sufficient samples of each symbol in order to generate a histogram for each of the symbols, as discussed at block 205 of FIG. 2. That is, FIG. 3 illustrates a test pattern that can be repeated to generate samples for creating histograms for each symbol.

Note that FIG. 3 illustrates a signaling technique (i.e., PAM4) that has four power levels (nominal levels 0, 1, 2, and 3). Ideally, each symbol would correspond to (have the same power as) one of the nominal levels. However, due to issues with the laser (e.g., inter-symbol interference (ISI), jitter, relative intensity noise (RIN), or bounded noise (e.g., crosstalk)), the transmission power of the symbols may not precisely align with the nominal power levels of PAM4. This is illustrated by some of the symbols having histograms where their means are different from the nominal level.

As discussed below, by creating histograms from repeating the test pattern the measurement system can derive, for every symbol in the test pattern, the nominal power level of the symbol, the root mean square (RMS) noise, and the probability of error (assuming a hard detection scheme). A hard detection scheme means there is a detection threshold between the nominal levels used to determine the level of the symbol (e.g., a 0, 1, 2, or 3).

Returning to the method 200, at block 210 the TDECQ calculator identifies a value of an additive noise parameter that satisfies a failure probability threshold. That is, as part of the TDECQ calculation, the calculator adds noise to the histograms (which causes the histograms to expand/widen and increases the failure probability). For example, the noise can be added via convolution of histograms. The TDECQ calculator can iteratively add noise at intervals until reaching the failure probability threshold.

In one embodiment, the failure probability is an average failure probability (e.g., an average FEC failure probability) determined as the noise parameter is changed. The TDECQ calculator can determine, as it adjusts the noise parameter, the maximum value of the noise parameter that results in the average FEC failure probability exceeding a threshold (where the threshold can be set by the user). For example, if the Hamming decoder can correct at most 3 errors in a codeword, the threshold can be when the average FEC failure probability results in more than 3 errors. Put differently, the TDECQ calculator can identify the amount of added noise that results in the likelihood of more than 3 errors in a codeword.

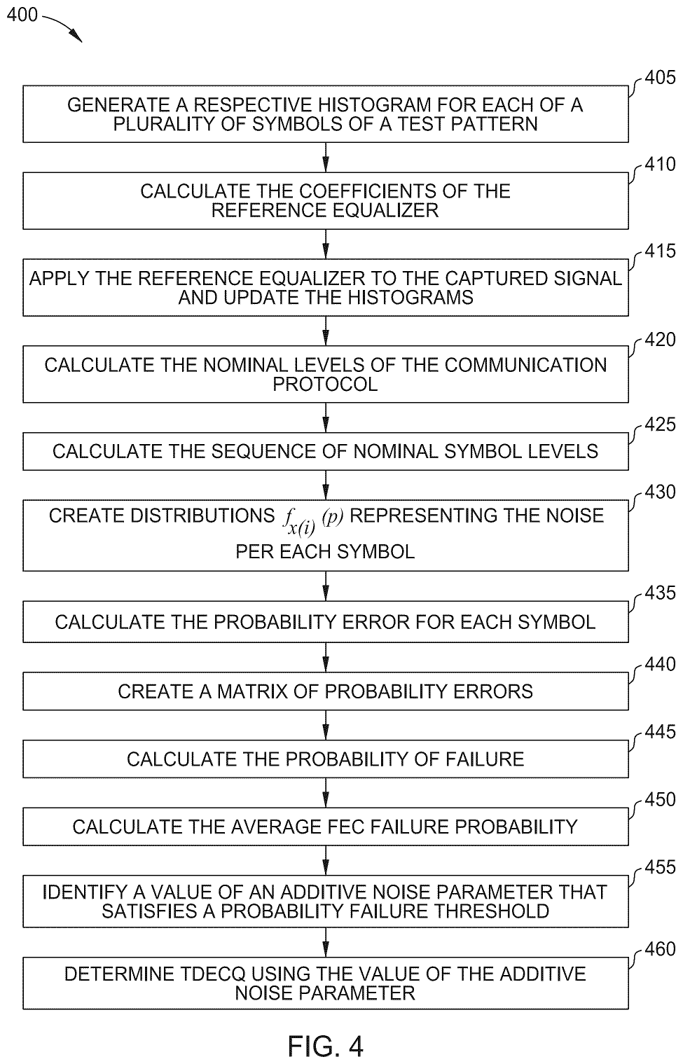

At block 215, the TDECQ calculator determines the TDECQ using the value of the additive noise parameter determined at block 210. In one embodiment, the method 200 can use the same equation to calculate TDECQ that is done currently, except using an additive noise parameter discussed in method 200. Previous TDECQ equations use a different additive noise parameter (referred to as G) which can be derived in a similar way to the description above by gradually increasing the additive noise until the target error ratio is achieved. However, the noise is added to a single histogram created from all the samples in the pattern, rather to each of the per-symbol histograms separately as described herein. The details of this equation will be discussed in FIG. 4.

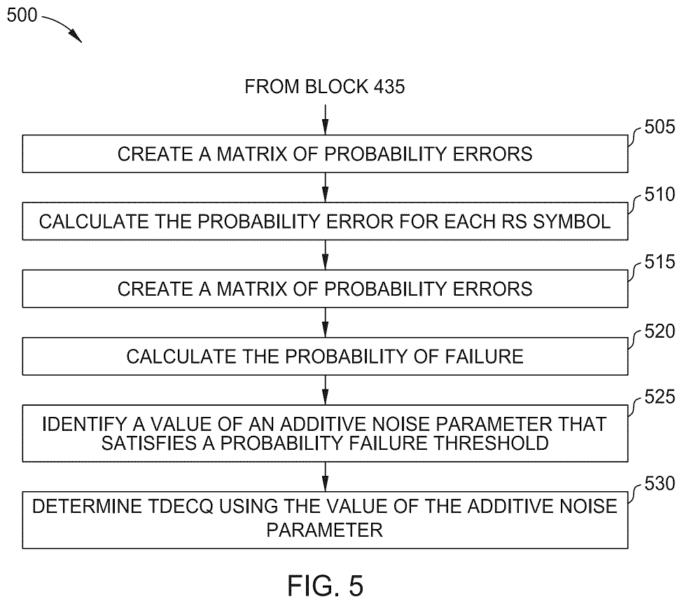

FIG. 4 is a flowchart of a method 400 for generating a TDECQ parameter for an inner FEC algorithm, such as a Hamming code. FIG. 5 will discuss a method 500 for generating a TDECQ parameter for an outer FEC algorithm, such as a Reed-Solomon code.

At block 405, the TDECQ calculator generates a respective histogram for each of a plurality of symbols of a test pattern. This can be performed using any of the techniques discussed at block 205 of FIG. 2. Moreover, the calculator can determine histograms for every symbol in the test pattern, or for a subset of the symbols.

In one embodiment, the RX captures a periodic sequence with a length that is the least common multiple (LCM) of the codeword length and the test pattern length. The test may use an integer number of codewords and an integer number of cycles of the test pattern. When using the inner Hamming code, a codeword is 128 bits which equals 64 PAM4 symbols. Because 64 and 65535 (i.e., the length of the SSPRQ test pattern) are coprime (the LCM is their product—i.e., 4194240), 64 repetitions of SSPRQ may be performed to generate the per symbol histograms.

In one embodiment, the histograms represent a random vector R(i), where i=0 to L-1 is the index of the PAM4 symbol within the N-repetition test pattern. That is, the histograms can be represented by a vector of histograms where each element in the vector is a random variable with a histogram associated with it. Normalized histograms can be denoted as a probability distribution f_{R(i)}(p), where p is an optical power level. That is, f_{R(i)}(p) is the probability of a particular symbol i being in a vicinity of a particular optical power level p.

At block 410, the TDECQ calculator calculates the coefficients of the reference equalizer. Any suitable technique for calculating the coefficients, such as minimum mean square error (MMSE), can be used. In one embodiment, the equalizer coefficients can be calculated before the histograms are created, and then applied to the signal, and then the histogram can be generated directly from the equalized signal. That is, block 410 can occur first, then the first part of block 415, and then block 405.

At block 415, the TDECQ calculator applies the reference equalizer to the captured signal and updates the histograms—e.g., equalizes the captured signals to generate equalized signals. In one embodiment, this can be the same process performed by previous versions of TDECQ, except applied to the per symbol histograms described here (rather than a single histogram).

In another embodiment, the equalizer coefficients can be calculated before the histograms are created, and then applied to the signal, and then the histogram can be generated directly from the equalized signal. That is, block 410 can occur first, then the first part of block 415, and then block 405.

At block 420, the TDECQ calculator calculates the nominal levels of the communication protocol—e.g., {P₀, P₁, P₂, P₃} for PAM4. For example, referring to FIG. 3, the TDECQ can calculate the nominal power levels labeled 0, 1, 2, and 3.

At block 425, the TDECQ calculator calculates the sequence of nominal symbol levels corresponding to the test pattern. This can be expressed as T(i) representing the optical power levels for each of the symbols i, where i=0 to L-1 is the index of the PAM4 symbol within the N-repetition test pattern, and where T(i) is selected from one of the four nominal values in PAM4—i.e., for each i, T(i) ∈{P₀, P₁, P₂, P₃}.

At block 430, the TDECQ calculator creates distributions f_{X(i)}(p) representing the noise per each symbol. In one embodiment, the calculator subtracts the nominal symbol level ({P₀, P₁, P₂, P₃}) corresponding to each symbol (or UI) from the samples, and creates the distributions f_{X(i)}(p) representing the random vector X(i)=R(i)−T(i). That is, f_{X(i)}(p) represents the noise after equalizing each symbol or UI. Put differently, X(i) represents the error between what the RX expected to receive but what it actually received. So X(i) is the histogram minus the nominal power level, which removes the nominal power level and leaves the deviation around the nominal power level. When the nominal power level is removed from the histograms, what is left is the noise.

At block 435, the TDECQ calculator calculates the probability of error for each symbol. The remaining blocks in the method 400 depend on the RMS additive noise parameter (referred to as σ).

For each PAM4 symbol index (i.e., from when i=0 to L-1), the TDECQ calculator calculates the probability error Pₑᵣᵣ(i). To do so, from the measured noise distribution f_{X(i)}(p) the TDECQ calculator calculates a noise-added distribution f_{Y(i)}(p), by convolution with a Gaussian with standard deviation C_{eq}σ, where C_{eq} is the noise gain of the coefficients of the equalizer determined at block 410. The equalizer coefficients may be recalculated for each value of σ (similar to the current TDECQ method) or only once.

In addition, the TDECQ calculator may calculate the vector of probabilities of error for each symbol:

$${P}_{e r r} ( i ) = \{ \begin{matrix}Prob ( Y ( i ) > {D}_{+ 1} ) & T ( i ) = {P}_{0} \\ Prob ( Y ( i ) > {D}_{+ 1} ) + Prob ( Y ( i ) < {D}_{- 1} ) & T ( i ) ∈ \{ {P}_{1} , {P}_{2} \} \\ Prob ( Y ( i ) < {D}_{- 1} ) & T ( i ) = {P}_{3}\end{matrix}$$

where D₊₁ and D₋₁ are the distances from the nominal symbol level to the adjacent decision level, calculated from {P₀, P₁, P₂, P₃}. This vector of probabilities is similar to a symbol error rate (SER) that is applied to each symbol in the sequence separately.

At block 440, the TDECQ calculator creates a matrix of probability errors Pₑᵣᵣ(n,k). In one embodiment, the TDECQ calculator creates the matrix Pₑᵣᵣ(n,k) by re-ordering the vector Pₑᵣᵣ for each symbol according to the effect of the Hamming de-interleaver included in the inner FEC, such that each row (a specific value of n, where k takes values from 0 to K-1=63) corresponds to one inner FEC (FECi) codeword. The row numbers n can range from 0 to 65534 for the inner Hamming FEC.

At block 445, the TDECQ calculator calculates the probability of failure P_{fail}(n) where the received signal has more errors than can be handled by the particular inner FEC decoder assumed to be used. For example, for the inner Hamming FEC, the TDECQ calculator may calculate, using the matrix Pₑᵣᵣ(n, k) and repeated convolutions, the probability of having more than 3 errors in a codeword of the received signal (again assuming the Hamming decoder can always correct 3 errors).

In one embodiment, calculating the probability of having more than t errors in a codeword, given P_{err(n,k)} for k=0 to K-1 can be performed by defining the Bernoulli probability distribution B_{n,k}=[1−P_{err(n,k)}, P_{err(n,k)}], and its corresponding polynomial:

$${B}_{n , k} ( x ) = ( 1 - {P}_{e r r ( n , k )} ) + {P}_{e r r ( n , k )} \cdot x$$

Then, the TDECQ calculator calculates the distribution of the number of errors in block n by convolution of probability distributions, which is equivalent to the product of the polynomials:

$${C}_{n} ( x ) = {\prod }_{k = 0}^{K - 1} {B}_{n , k} ( x ) = {\sum }_{i = 0}^{K} {c}_{n , i} {x}^{i}$$

The TDECQ calculator can then calculate the probability of having more than terrors in block n, P_{fail}(n), which is calculated from the coefficients c, of the polynomial product Cₙ(x) as follows:

$${P}_{fail} ( n ) = {\sum }_{i = t + 1}^{K} {c}_{n , i} = 1 - {\sum }_{i = 0}^{t} {c}_{n , i}$$

In addition, the embodiments herein can also be used with soft decoding and hard decoding. In one embodiment of the Hamming code, a soft decoder can generally correct 3 errors, but a hard decoder may be able to correct at most 2 errors.

At block 450, the TDECQ calculator calculates the average FEC failure probability from the probability of failure of the n rows—i.e., avg P_{fail}=P̅_̅{̅f̅a̅i̅l̅}̅(̅n̅)̅.

At block 455, the TDECQ calculator identifies a value of an additive noise parameter that satisfies a failure probability threshold. This can be the same process as performed at block 210 of the method 200.

In one embodiment, the TDECQ calculator compares the average FEC failure probability to the failure probability threshold to see if the average FEC failure probability exceeds the threshold. If not, the TDECQ calculator can repeat (or perform iteratively) blocks 435-450 where the noise parameter a is increased. Put differently, the TDECQ calculator can increase the current value of the noise in the histograms each time it iterates through blocks 435-450 until the calculator identifies the value of the noise parameter a that results in an average FEC failure probability that meets (or exceeds) the failure probability threshold, which then lets the TDECQ calculator know that the value of the noise parameter used in the previous iteration was the maximum value of σ (referred to as σ_{FECi}) that still satisfies the failure probability threshold maximum P_{fail}. For example, the TDECQ calculator can increase the noise parameter σ at predefined intervals.

In one embodiment, the failure probability threshold is the maximum P_{fail}. Maximum P_{fail} for the FECi can be chosen based on its contribution to the outer RS-FEC failure probability, which can be equivalent to the maximum random bit error rate (BER) allowed with the outer RS-FEC—e.g., 2.4e-4. However, this is just one example value of the failure probability threshold. For example, the proposed maximum P_{fail} for the Ethernet standard is 2.8e-3.

Once the value of the additive noise parameter σ_{FECi} is identified, at block 460 the TDECQ calculator determines TDECQ using that value of the additive noise parameter. One example of the TDECQ calculation is shown in the following Equation:

$$TDECQ = 10 {log}_{10} \frac{{OMA}_{outer}}{6 {Q}_{t} \sqrt{{σ}_{S}^{2} + {σ}_{FECi}^{2}}} = 10 {log}_{10} \frac{{OMA}_{outer}}{\sqrt{{σ}_{S}^{2} + {σ}_{FECi}^{2}}} - 10 {log}_{10} ( 6 {Q}_{t} )$$

Note, OMAₒᵤₜₑᵣ, σₛ, and σ_{FECi} are in mW and TDECQ is a pure number (expressed in dB). Also, Qₜ is a constant which originally represented the number of standard deviations required to get an error probability of 4.8e-4 in a Gaussian distribution

$$( {Q}^{- 1} ( \frac{2}{3} \cdot 4.8 \cdot {10}^{- 4} ) ) .$$

This constant is not directly related to the FECi failure probability, but in one embodiment, for consistency with the existing method of TDECQ calculation (which results in TDECQ=0 for an ideal signal), it can be left unchanged.

In this manner, method 400 results in a TDECQ that is an improved metric for expressing the likelihood of an optical TX producing correlated errors, which is an important metric for inner FEC algorithms which are particularly sensitive to these types of errors.

FIG. 5 is a flowchart for generating a TDECQ parameter for an outer FEC, according to one embodiment. The method 500 is discussed in the context of the Reed Solomon (RS)-FEC which is one example of an outer FEC, however the embodiments can be apply to any suitable outer FEC.

For the RS-FEC code, the codewords length is 5440 bits=2720 PAM4 symbols. In that case, L=LCM (65535, 2720)=2097120, which contains 2097120/5=419424 RS-FEC symbols or 419424/544=771 codewords.

The method 500 begins at block 435 of method 400 where the TDECQ calculator has calculated the probability error Pₑᵣᵣ(i) for each symbol in the test pattern. At block 505, the TDECQ calculator creates a matrix of probability errors Pₑᵣᵣ(n, k) using the probability error Pₑᵣᵣ(i) for each symbol. In one embodiment, the TDECQ calculator re-orders the vector Pₑᵣᵣ according to the effect of the Physical Coding Sublayer (PCS) symbol distribution to create the matrix Pₑᵣᵣ(n,k), such that each row (one value of n, with k=0 to 4) corresponds to a RS-FEC symbol (where 10 bits=5 PAM4 symbols). In this example the rows n range from 0 to 419423. Further, the PCS symbol distribution can depend on the specific Physical medium-dependent (PMD) and data rate specification. As an example, for 200 Gb/s per lane PMD, each consecutive 5 PAM4 symbols constitute an RS-FEC symbol, which means the ordering is:

$${P}_{err} ( n , k ) = {P}_{err} ( ⌊ i / 5 ⌋ , i mod 5 ) .$$

At block 510, the TDECQ calculator calculates the probability error P_{RS_sym}(n) for each RS symbol. The probability error P_{RS_sym}(n) is the complementary of having no errors in any of the PAM4 symbols and is represented by the following equation:

$${P}_{RS \_ sym} ( n ) = 1 - {\prod }_{k = 0}^{4} ( 1 - {P}_{e r r} ( n , k ) )$$

At block 515, the TDECQ calculator creates a matrix of probability errors P_{RS_sym}(n, k) by reordering the resulting vector, where n=0 to 770, and each row (k=0 to 543) represents an RS-FEC codeword.

At block 520, the TDECQ calculator calculates the probability of failure P_{fail}(n) where the RS-FEC is unable to correct the errors in a received codeword. For example, the probability of failure P_{fail}(n) can be the probability of having more than t=15 errors out of the K=544 symbols. In one embodiment, the probability of failure P_{fail}(n) is calculated from Pₑᵣᵣ(n, k), using repeated convolutions.

At block 525, the TDECQ calculator identifies a value of an additive noise parameter that satisfies a failure probability threshold. As discussed in FIGS. 2 and 4, the TDECQ calculator can adjust the noise parameter and repeat blocks 435 of method 400 and blocks 505-520 in method 500 until the calculator identifies the value of the noise parameter σ that results in an average FEC failure probability that meets (or exceeds) the failure probability threshold, which then lets the TDECQ calculator know that the value of the noise parameter used in the previous iteration was the maximum value of σ (referred to as σ_{RSFEC}) that still satisfies the failure probability threshold maximum P_{fail}. For RS-FEC, the maximum P_{fail} may be chosen as the maximum RS-FEC failure probability allowed by the Ethernet standard, e.g., 8e-13.

Once the value of the additive noise parameter σ_{RSFEC} is identified, at block 530 the TDECQ calculator determines TDECQ using that value of the additive noise parameter. One example of the TDECQ calculation for RS-FEC is shown in the following Equation:

$$TDECQ = 10 {log}_{10} \frac{{OMA}_{outer}}{6 {Q}_{t} \sqrt{{σ}_{S}^{2} + {σ}_{FECi}^{2}}} = 10 {log}_{10} \frac{{OMA}_{outer}}{\sqrt{{σ}_{S}^{2} + {σ}_{FECi}^{2}}} - 10 {log}_{10} ( 6 {Q}_{t} )$$

In this manner, method 500 results in a TDECQ that is improved metric for expressing the likelihood of an optical TX producing correlated errors, which is an important metric for outer FECs.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
generating a respective histogram for each of a plurality of symbols of a test pattern by receiving the test pattern repeatedly from an optical transmitter;
identifying a value of an additive noise parameter that satisfies a failure probability threshold by determining a probability of errors for each of the plurality of symbols using different values of the additive noise parameter; and
determining Transmitter and Dispersion Eye Closure Quaternary (TDECQ) using the value of the additive noise parameter.

2. The method of claim 1, wherein identifying the value of the additive noise parameter comprises iteratively:
determining a respective probability of errors for each of the plurality of symbols using a current value of the additive noise parameter;
determining an average failure probability from the respective probabilities of errors;
comparing the average failure probability to the failure probability threshold; and
selecting a new value of the additive noise parameter until determining the current value of the additive noise parameter satisfies the failure probability threshold.

3. The method of claim 1, wherein the failure probability threshold corresponds to a probability of failure of a forward error correction (FEC) algorithm.

4. The method of claim 3, wherein the value of the additive noise parameter is a maximum value of the additive noise parameter that still satisfies a maximum probability of failure of the FEC algorithm.

5. The method of claim 1, further comprising:
equalizing signals generated by transmitting the test pattern, wherein each of the respective histograms is generated based on the equalized signals.

6. The method of claim 5, further comprising:
generating a random vector storing, for each of the signals, a difference between a respective one of the histograms and a corresponding power level, wherein the corresponding power level is selected from a plurality of power levels of a signaling technique used to transmit the test pattern.

7. The method of claim 6, wherein determining the probability of errors for each of the plurality of symbols is further based on values stored in the random vector.

8. The method of claim 6, wherein the signaling technique is pulse amplitude modulation (PAM).

9. A measurement system, comprising:
one or more memories; and
one or more processors communicatively coupled to the one or more memories, the one or more processors configured to, individually or collectively, perform operations comprising:
generating a respective histogram for each of a plurality of symbols of a test pattern by receiving the test pattern repeatedly from an optical transmitter;
identifying a value of an additive noise parameter that satisfies a failure probability threshold by determining a probability of errors for each of the plurality of symbol using different values of the additive noise parameter; and
determining TDECQ using the value of the additive noise parameter.

10. The measurement system of claim 9, wherein identifying the value of the additive noise parameter comprises iteratively:
determining a respective probability of errors for each of the plurality of symbols using a current value of the additive noise parameter;
determining an average failure probability from the respective probabilities of errors;
comparing the average failure probability to the failure probability threshold; and
selecting a new value of the additive noise parameter until determining the current value of the additive noise parameter satisfies the failure probability threshold.

11. The measurement system of claim 9, wherein the failure probability threshold corresponds to a probability of failure of a forward error correction (FEC) algorithm.

12. The measurement system of claim 11, wherein the value of the additive noise parameter is a maximum value of the additive noise parameter that still satisfies a maximum probability of failure of the FEC algorithm.

13. The measurement system of claim 9, wherein the operations further comprise:
equalizing signals generated by transmitting the test pattern, wherein each of the respective histograms is generated based on the equalized signals.

14. The measurement system of claim 13, wherein the operations further comprise:
generating a random vector storing, for each of the signals, a difference between a respective one of the histograms and a corresponding power level, wherein the corresponding power level is selected from a plurality of power levels of a signaling technique used to transmit the test pattern.

15. The measurement system of claim 14, wherein determining the probability of errors for each of the plurality of symbols is further based on values stored in the random vector.

16. The measurement system of claim 14, wherein the signaling technique is pulse amplitude modulation (PAM).

17. A computer readable medium comprising, in any combination, computer program code, which, when executed by one or more processors, performs operations comprising:
generating a respective histogram for each of a plurality of symbols of a test pattern by receiving the test pattern repeatedly from an optical transmitter;
identifying a value of an additive noise parameter that satisfies a failure probability threshold by determining a probability of errors for each of the plurality of symbols using different values of the additive noise parameter; and
determining TDECQ using the value of the additive noise parameter.

18. The computer readable medium of claim 17, wherein identifying the value of the additive noise parameter comprises iteratively:
determining a respective probability of errors for each of the plurality of symbols using a current value of the additive noise parameter;
determining an average failure probability from the respective probabilities of errors;
comparing the average failure probability to the failure probability threshold; and
selecting a new value of the additive noise parameter until determining the current value of the additive noise parameter satisfies the failure probability threshold.

19. The computer readable medium of claim 17, wherein the failure probability threshold corresponds to a probability of failure of a forward error correction (FEC) algorithm.

20. The computer readable medium of claim 19, wherein the value of the additive noise parameter is a maximum value of the additive noise parameter that still satisfies a maximum probability of failure of the FEC algorithm.
